(19) United States
(12) Patent Application Publication
(10) Pub. No.: US 2008/0038705 A1
(43) Pub. Date: Feb. 14, 2008

(54) SYSTEM AND METHOD FOR ASSESSING STUDENT PROGRESS AND DELIVERING APPROPRIATE CONTENT

(76) Inventors: Daniel R. Kerns, Mercer Island, CA (US); Roy Leban, Redmond, WA (US); Benjamin W. Slivka, Clyde Hill, WA (US); Nigel J. Green, Bellevue, WA (US); Mickelle Weary, Kirkland, WA (US); Jennifer Seery, Renton, WA (US)

Correspondence Address: HAHN AND MOODLEY, LLP, P.O. BOX 52050, MINNEAPOLIS, MN, 55402, US

(21) Appl. No.: 11/777,984

(22) Filed: Jul. 13, 2007

Related U.S. Application Data
(60) Provisional application No. 60/883,416, filed on Jan. 4, 2007.
(60) Provisional application No. 60/830,937, filed on Jul. 14, 2006.

(51) Int. Cl. G09B 5/00; G09B 7/00

(52) U.S. Cl. 434/309; 434/308; 434/322; 434/327; 434/353

(57) ABSTRACT

Embodiments of the present invention disclose an educational system that delivers educational content/instruction to students in the form of lessons, and techniques embodied in the educational system to assess student/learner progress within and between lessons and to deliver appropriate content to students. Advantageously, the educational system maps lessons and lesson content to items in a standards hierarchy, thus allowing a snapshot showing how the student is doing compared with the standards to be taken at any time

This application claims the benefit of priority to U.S. Provisional Patent Application Nos. 60/830,937 and 60/883,416, each of which is hereby incorporated by reference.

### FIELD

Embodiments of the invention relate generally to the field of education, and more specifically to the field of delivering educational content, including lessons, to students using technological means.

### BACKGROUND

Educational systems utilizing computers may be used to provide educational content to learners. Such educational content may include multimedia content rich in, e.g. sound, graphics, video, etc. to provide a compelling learning experience. Assessments refer to how such educational systems attempt to determine a learner's mastery of the educational content

### SUMMARY

Embodiments of the present invention disclose an educational system that delivers educational content/instruction to students in the form of lessons and techniques embodied in the educational system to assess student/learner progress within and between lessons and to deliver appropriate content to students. Advantageously, the educational system maps lessons and lesson content to items in a standards hierarchy, thus providing a snapshot or report showing how the student is doing compared with the standards. Such a snapshot may be produced at any tine. Other embodiments and features of the present invention will become apparent from the detailed description below.

### BRIEF DESCRIPTION

While the appended claims set forth the features of the present invention with particularity, the invention, together with its objects and advantages, will be more readily appreciated from the following detailed description, taken in conjunction with the accompanying drawings wherein:

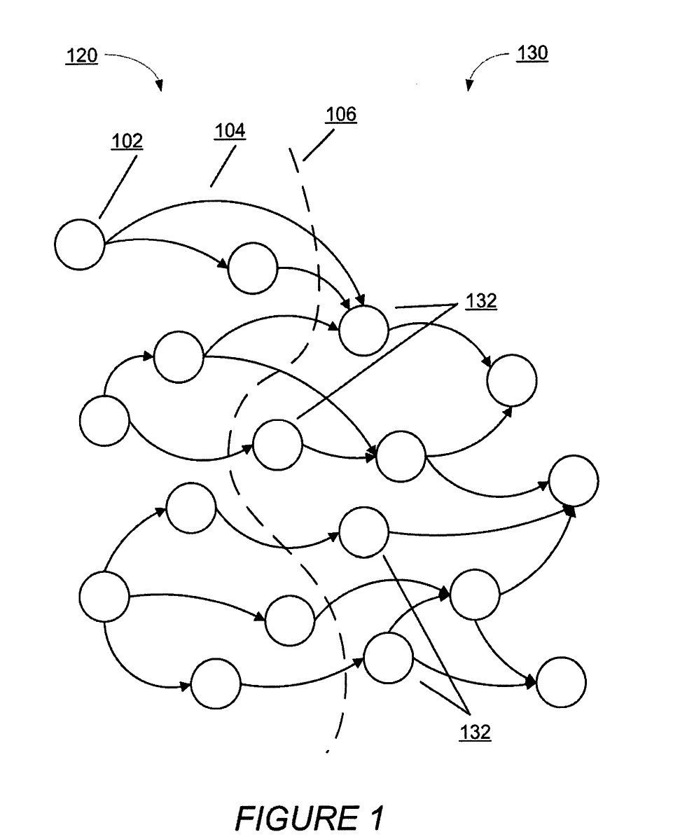

FIG. 1 shows a partially-ordered graph of lessons, representing potential lesson sequences based on the requirements and assessments of each lesson, in which some lessons have already been completed and some are yet to be completed, in accordance with one embodiment of the invention.

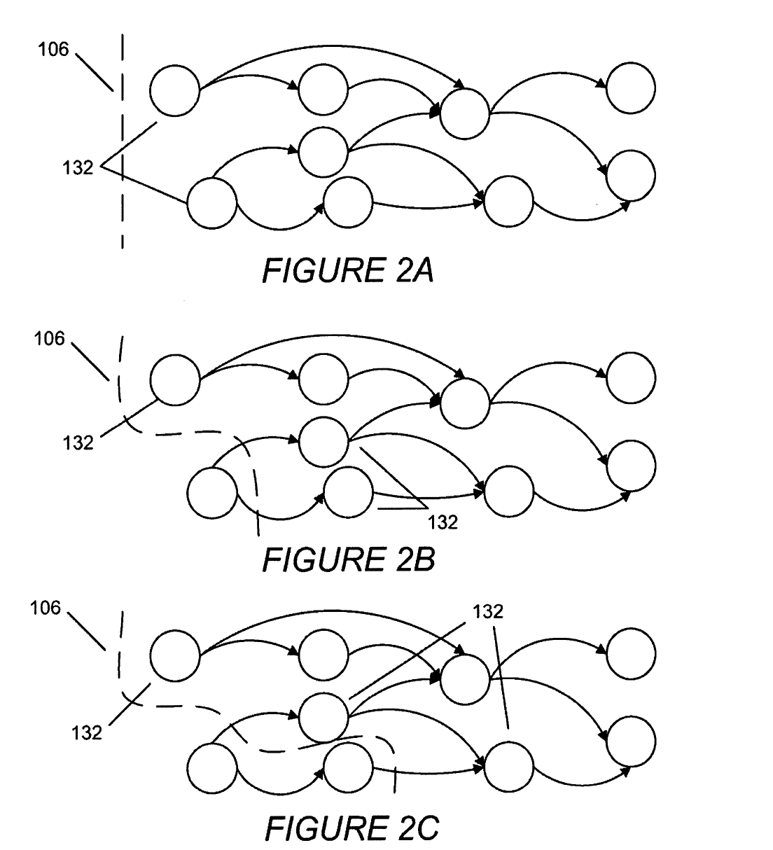

FIGS. 2A, 2B and 2C show a sequence of partially-ordered graphs of lessons, in accordance with one embodiment of the invention wherein changes in the graph after a series of successfully completed lessons may be seen.

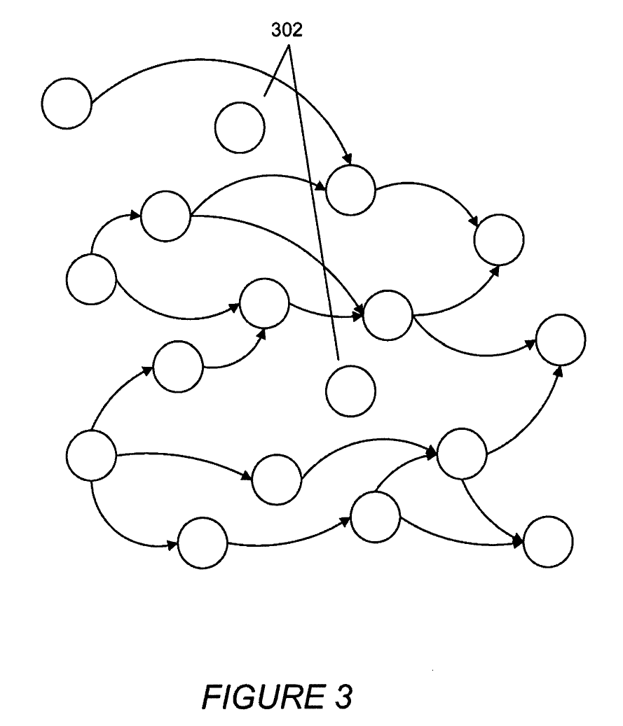

FIG. 3 shows a partially-ordered graph of lessons that has been modified by adaptation for a student, in accordance with one embodiment of the invention wherein some lessons are no longer available or reachable.

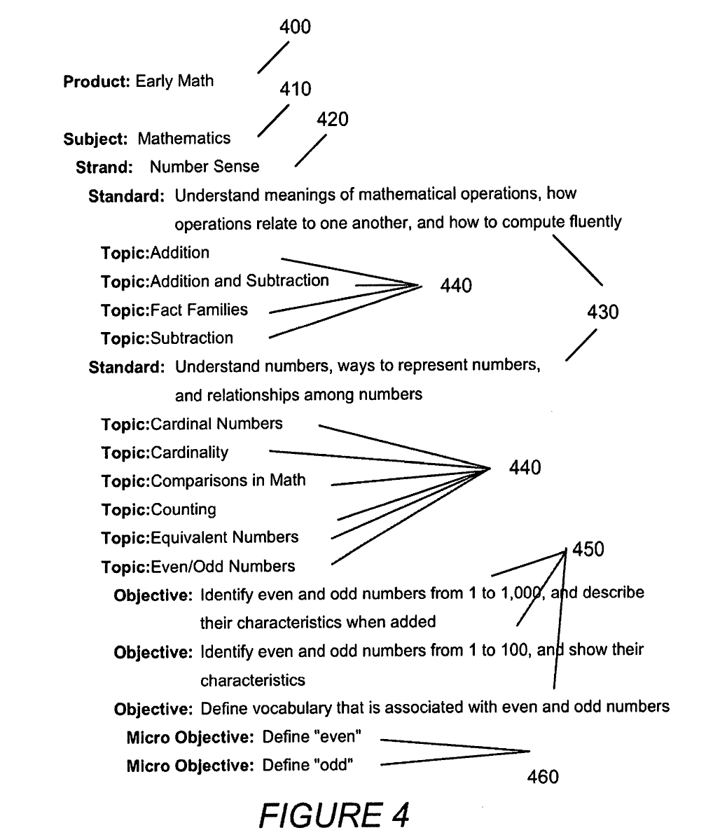

FIG. 4 shows an example of a portion of a standards hierarchy in accordance with one embodiment of the invention.

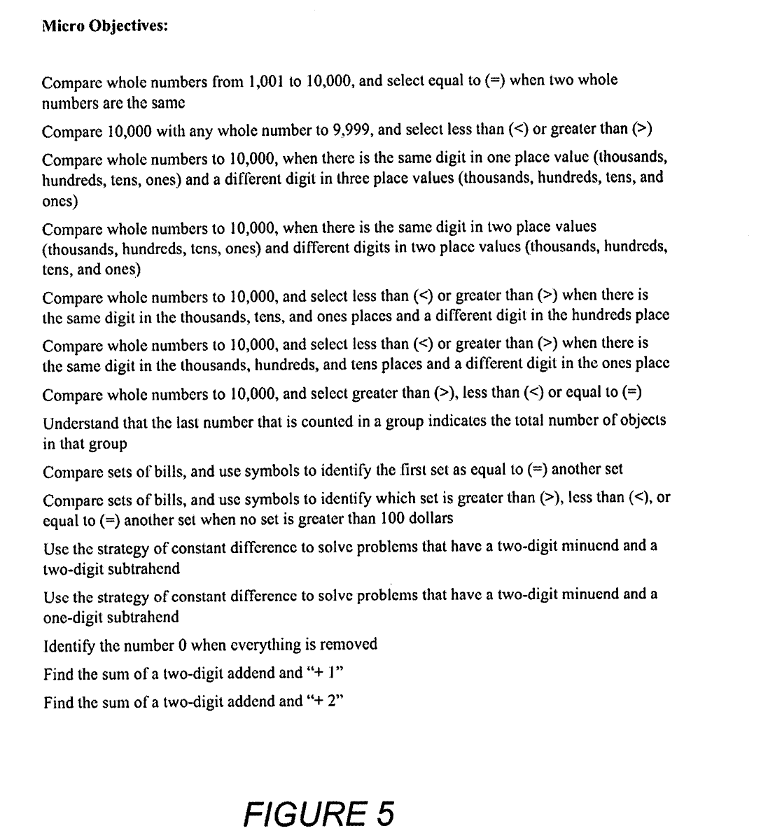

FIG. 5 shows micro-objectives, in accordance with one embodiment of the invention.

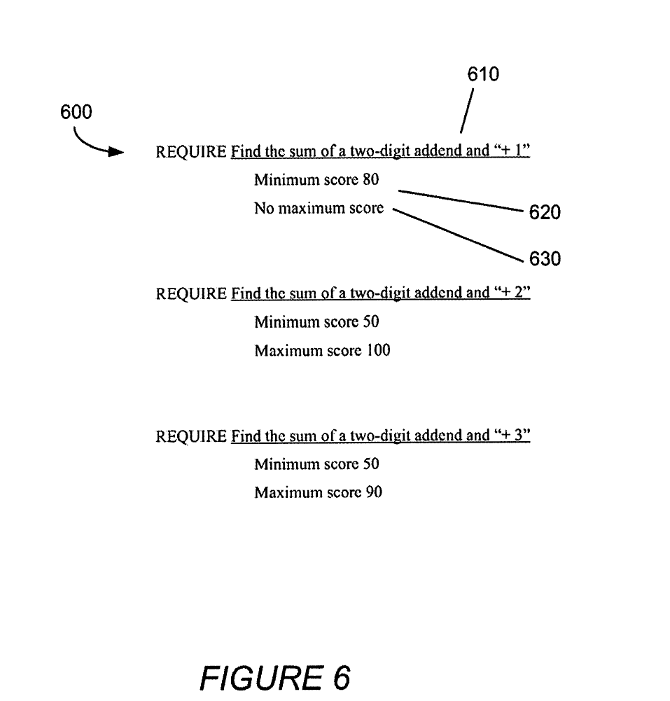

FIG. 6 shows an example of requirements for a lesson in accordance with one embodiment of the invention.

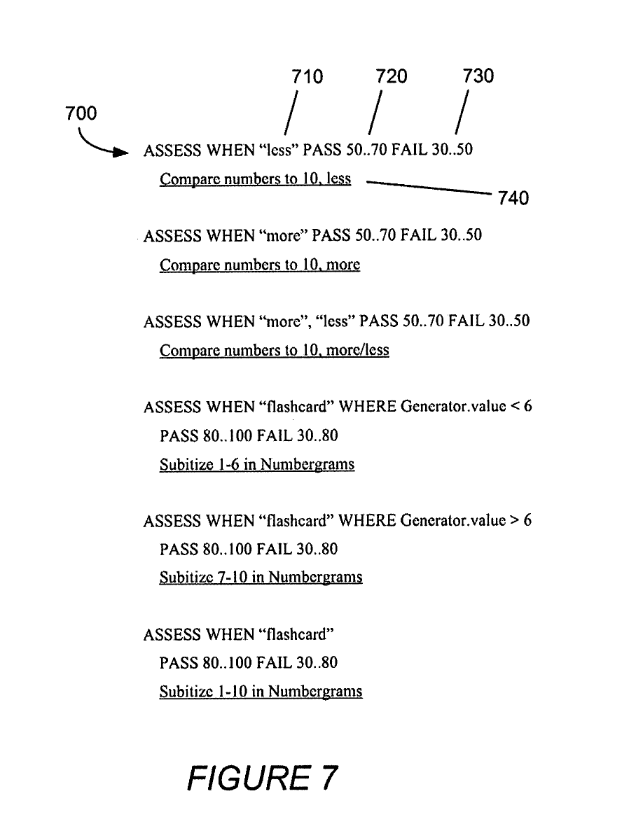

FIG. 7 is an example of assessments for a lesson, in accordance with one embodiment of the invention.

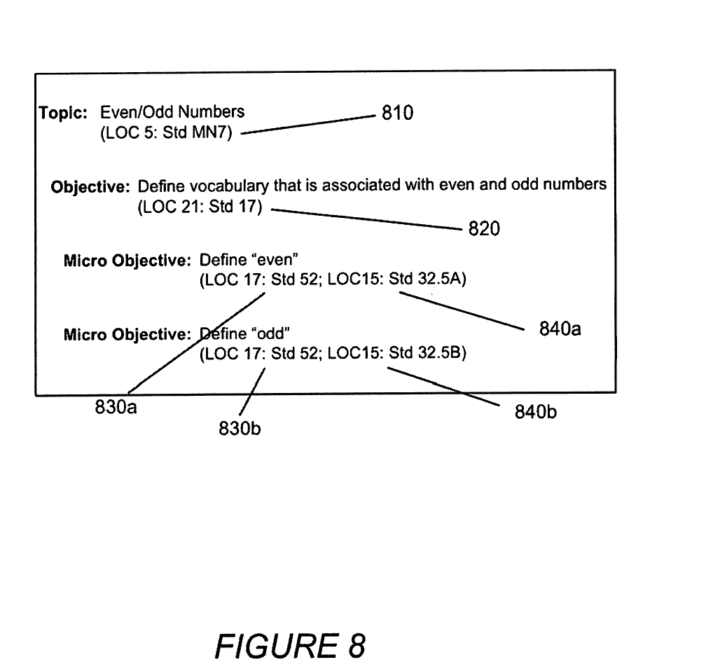

FIG. 8 shows a portion of a standards hierarchy which has been mapped to local standards in accordance with one embodiment of the invention.

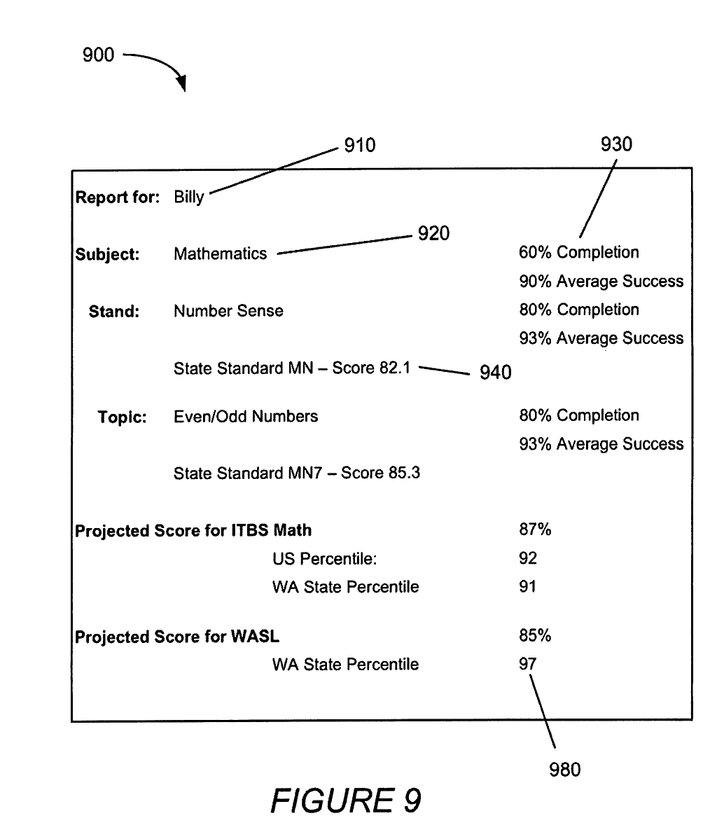

FIG. 9 shows an exemplary report for a student demonstrating how the student is measured against the standards, in accordance with one embodiment of the invention.

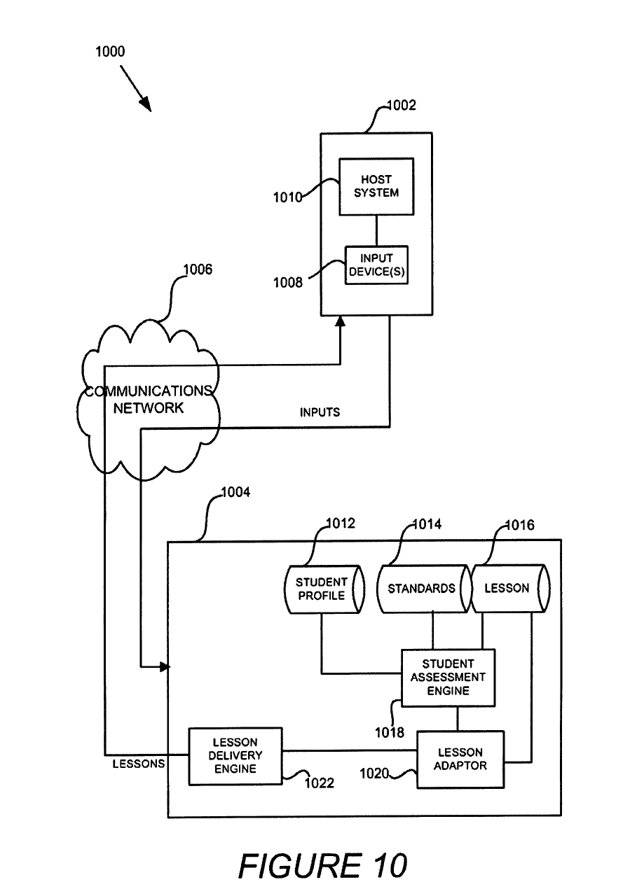

FIG. 10 shows a network environment within which embodiments of the present invention may be practiced, the environment including a client system and a server system in accordance with one embodiment of the invention.

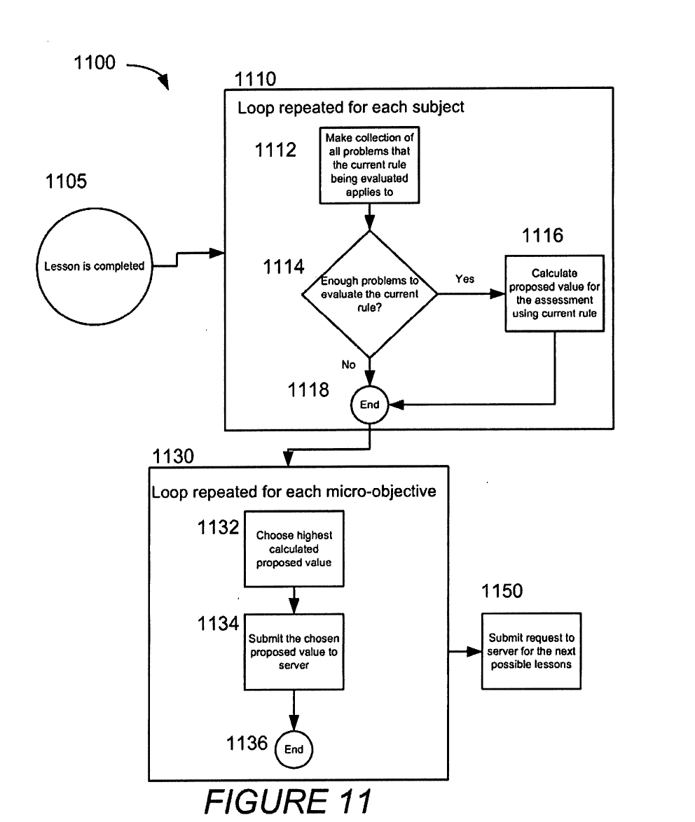

FIG. 11 shows an exemplary process for adjusting a student's profile in response to a completed lesson, in accordance with one embodiment of the invention.

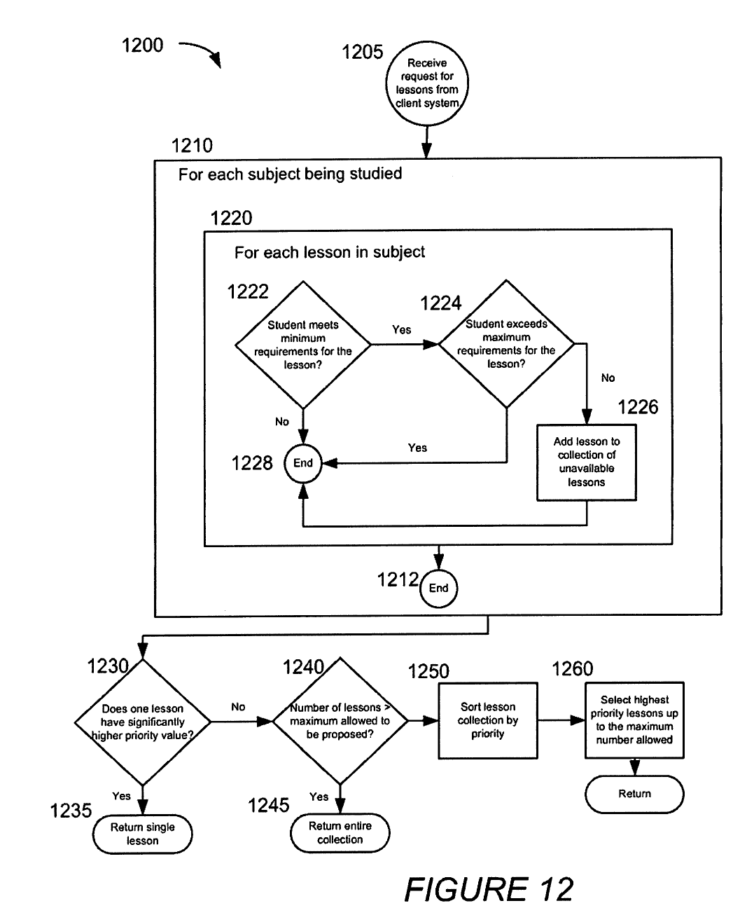

FIG. 12 shows an exemplary process for proposing a set of lessons for a student, in accordance with one embodiment of the invention.

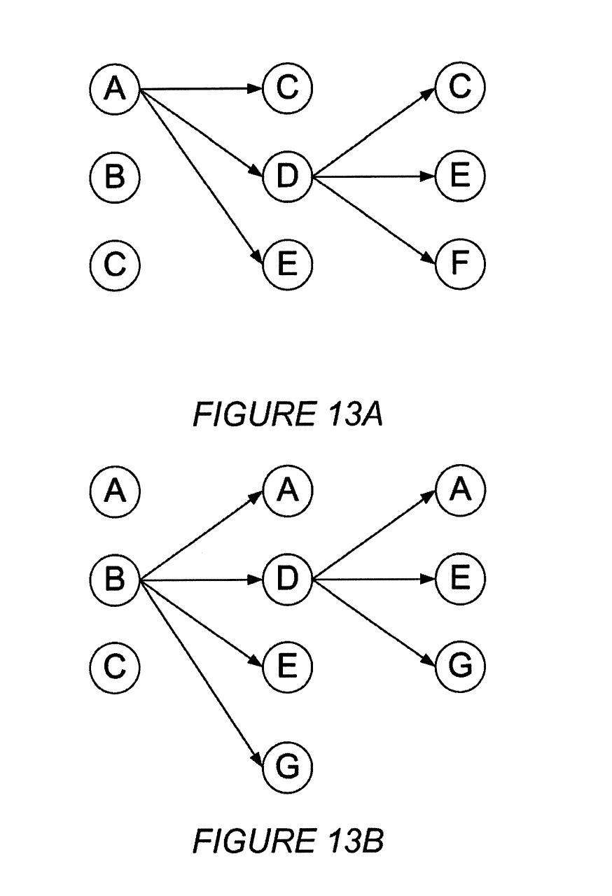

FIG. 13A shows a sequence of lessons taken by a student, in accordance with one embodiment of the invention.

FIG. 13B shows an alternate route sequence of lessons taken by a student in accordance with one embodiment of the invention.

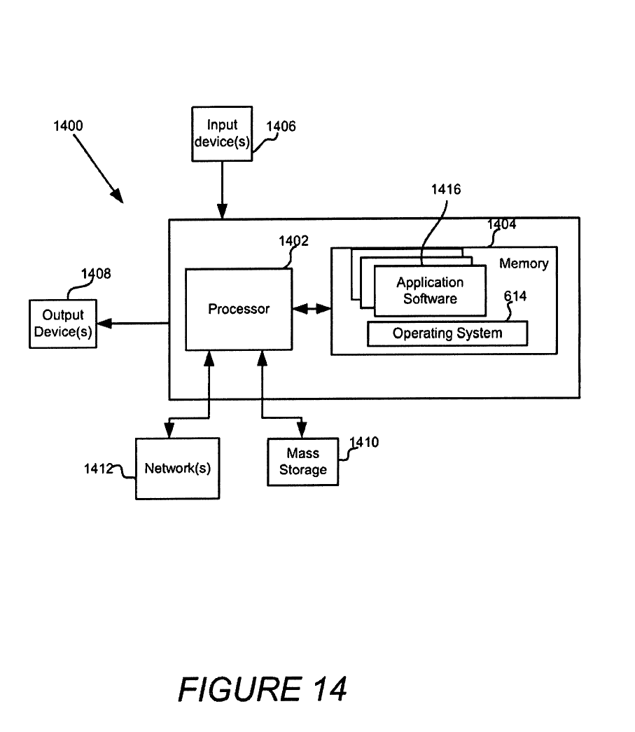

FIG. 14 shows a high-level block diagram of hardware that may be used to implement any of the client and server systems, in accordance with one embodiment of the invention.

### DETAILED DESCRIPTION

In the following description, for purposes of explanation, numerous specific details are set forth in order to provide a thorough understanding of the invention. It will be apparent, however to one skilled in the art that the invention can be practiced without these specific details. In other instances, structures and devices are shown in block diagram form only in order to avoid obscuring the invention.

Reference in this specification to “one embodiment” or “an embodiment” means that a particular feature, structure, or characteristic described in connection with the embodiment is included in at least one embodiment of the invention. The appearance of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Although the following description contains many specifics for the purposes of illustration anyone skilled in the art will appreciate that many variations and/or alterations to said details are within the scope of the present invention. Similarly, although many of the features of the present invention are described in terms of each other, or in conjunction with each other, one skilled in the art will appreciate that many of these features can be provided independently of other features. Accordingly, this description of the invention is set forth without any loss of generality to, and without imposing limitations upon, the invention.

Throughout this description, the present invention will be described using terminology of computers, personal computers, and the internet, along with terminology related to current educational methods and systems. However, one skilled in the art will appreciate that such terminology is intended to be non-limiting.

Broadly, embodiments of the invention disclose an educational system that delivers educational content/instruction to students in the form of lessons, and techniques embodied in the educational system, to assess student/learner progress within and between lessons and to deliver appropriate content to students. It is important to appreciate that a “lesson” refers to a unit of experience and may not be fixed in terms of its definition, size, or complexity in the sense that a “classroom lesson” is fixed. Advantageously, the educational system maps lessons and lesson content to items in a set of standards, thus providing a snapshot or report showing how the student is doing compared with the standards. Such a snapshot may be produced at any time.

Turning now to FIG. 10 of the drawings, there is shown an environment 1000 within which embodiments of the invention may be practiced. As will be seen, the environment 1000 comprises a client system 1002 coupled to a server system 1004 via a communications network 1006. The client system 1002 may represent any client computing device including e.g. a personal computer (PC), a notebook computer, a smart phone, etc. At least conceptually, the client system 1002 may be thought of as including one or more input/output (I/O) devices 1008 coupled to a host system 1010. In accordance with different embodiments, the I/O devices 1008 may include input devices such as a computer mouse or pen, a touch-sensitive screen, joystick, data gloves and a keyboard. Additionally, the input devices 1008 may further comprise input devices for capturing biometric information pertaining to a learner. The latter category of input devices may include a camera for facial expression detection and for eye motion capture/detection, a voice recorder, and a heart rate monitor. T he I/O devices 1008 may include output devices such as a display, a sound playback device, or a haptic device for outputting braille. Hardware that may be used to realize the client system 1002, in accordance with one embodiment, is illustrated in FIG. 14 of the drawings. Although in FIG. 10 of the drawings only one client system 1002 is shown, it is to be understood that in practice several such client systems 1002 may be coupled to the server system 1004 via the communications network 1006.

In a broad sense, the communications network 1006 represents any network capable of bridging communications between the client system 1002 and the server system 1004. For purposes of the present description, the communications network 1006 is to be understood to include a Wide-Area Network (WAN) in the form of the World Wide Web (WWW) or the Internet as it is commonly referred to. Given that the communications network 1006, in one embodiment includes the Internet, the server system 1004, in one embodiment may comprise a Web server housed in a data center. In one embodiment, the server system 1004 may be implemented as a server farm or server cluster. Such a server farm may be housed in a single data center or in multiple data centers.

At a high-level, the server system 1004 provides educational content in the form of lessons that are executed on the client system 1002. Responsive to the execution of the lessons, the client system 1002 captures a student's responses and transmits same in the form of an input to the educational system 1004 for assessment and lesson sequencing as will be described later.

Focusing now on the server system 1004, it will be seen that the server system 1004 includes as its functional components a student profile database 1012, a standards database 1014, and a lesson database 1016. Additionally, the server system 1004 comprises a student assessment engine 1018, a lesson adapter 1020, and a lesson delivery engine 1022. Hardware that may be used to realize or implement the server system 1004, in accordance with one embodiment of the invention, is illustrated in FIG. 14 of the drawings. As noted above, in one embodiment, the server system 1004 may be implemented as a server farm housed in a single data center or in multiple data centers, and may serve a large number of students.

In one embodiment, the student profile database 1012 comprises individual student profiles. By way of example, each student profile may comprise personal information such as a student's age, gender, geographic location, interests and hobbies, etc. Learning objectives or goals in the form of minimum standards set by a standards authority, may be resident in the standards database 1014, in accordance with one embodiment. Examples of the standards authority include State and local educational departments. Lessons are stored in the lesson database 1016.

Standards, Assessments, and Requirements

In one embodiment, the educational standards known to the system 1004 are embodied in the form of a hierarchical tree resident in the database 1014. Broadly, the educational standards represent a knowledge taxonomy comprising multiple levels of objectives organized hierarchically or in some other way, for example in accordance with a network or any other topology. An example of such a standards hierarchy is shown in FIG. 4 of the drawings. In one embodiment, the hierarchy consists of the following items: product 400, subject 410, strand 420, standard 430, topic 440, objective 450, and micro-objective 460. Each level in the standards hierarchy describes, at a successively more detailed level, a body of knowledge that may, be taught and learned. Micro-objectives, as shown in FIG. 5, are the lowest level (or finest granularity) objectives used in the preferred embodiment and represent the lowest level that may be measured. Some embodiments may also have nano-objectives representing specific facts or problems, or other additional levels, below in micro-objectives. In one embodiment, the lowest level of objectives used in the system 1004 represents specific pieces of knowledge to be learned. Some embodiments may also have flatter hierarchies, with fewer levels. In one embodiment, items in the standards hierarchy are referred to by their name and position. Other embodiments may use unique identifiers taxonomical identifiers, or reference numbers into the hierarchy.

In one embodiment, the standards hierarchy is stored in and accessed from multiple related tables in a standard Structured Query Language (SQL) database. Other embodiments may use different storage mechanisms.

One embodiment of the present invention relates to a method by which lessons are related to requirements and assessments. Another embodiment of the present invention is the method by which the sequence of lessons is derived from the requirements and assessments,

In other systems, there are a number of ways in which lessons are sequenced including manually and not at all, in which case the student selects the order of the lessons. There are also hybrids in which groups of lessons are sequenced and within those groups, the student selects the order. Such systems also track student process through assessments, allowing the student's progress to be tracked (e.g., in a student profile). Most such assessments track lesson completion only.

FIG. 6 shows micro-objective requirements 600 for an example lesson under one embodiment the inventions. In each micro-objective requirement, one or more micro-objectives 610 to are specified, along with a minimum score 62O for the micro-objective(s) and a maximum score 630 for that micro-objective. In one embodiment, a micro-objective requirement is considered to be met if all minimum requirements are satisfied and no maximum requirement is exceeded. In one embodiment, a lesson is available to a student if all micro-objective requirements are met.

In the foregoing, lesson availability was based on micro-objective requirements. However, it is to be appreciated, that in accordance with the techniques of the present invention, lesson and availability may be based on other elements within the knowledge taxonomy such as topics, strands, or objectives. Thus, in accordance u the techniques of the present invention each problem given in each lesson may be attached to one or more particular elements in the knowledge taxonomy, e.g. to a micro-objectives, objective topic, or strand, said elements to be assessed within the lesson. In one embodiment, the attachment of problems to the elements occurs when the lesson is run, not in advance, and it is attached in the context that the problem is given so that even randomly generated problems may be assigned properly. FIG. 7 shows micro-objective assessments 700 for an example lesson. In each micro-objective assessment, problem types 710 may optionally be specified. If problem types are specified, the assessment only applies to problems of the specified type. Each micro-objective assessment also specifies target score values for when the student succeeds 720 and does not succeed 730, along with one or more micro-objectives which are to have a score value calculated for the given problem type.

In one embodiment, each student has a score for each micro-objective which is a percentage of mastery, ranging from 0 to 100%. These scores are fixed at the time the student masters the micro-objective and does not change in the future. Alternate embodiments may revisit such scores and adjust them as students continue to learn.

“Mastery decay” or simply “decay” refers to the extent/rate at which students forget knowledge recently learned. To the extent that “mastery decay” exists, in one embodiment a system 1004 with a sufficient quantity of lessons will automatically take decay into account in follow-up lessons. When decay occurs, a student's scores can go down in a follow-up lesson, possibly forcing them to revisit lessons they previously completed. Such a revisitation would probably be with a higher earn score than the previous time and thus the lesson might appear different to the student because of in-lesson adaptation on.

If a lesson determines that a student's mastery has fallen, this will be reflected in a lowering of the students scores, and the system can automatically move the student to an earlier lesson to help improve their mastery of their relevant micro-objectives.

Alternate embodiments, particularly those that use nano-objectives, may choose to use scores with a different range and may even choose to have only binary values (0 and 1) as scores for their lowest level of objectives. Some alternate embodiments may choose to use score ranges including a range that represents an explicit failure to learn as opposed to a lack of learning. Some embodiments may have specials score values like “don't knows”, and “deemed incapable of learning”.

The micro-objectives may be assessed on any number of criteria, including, but not limited to, time per question, overall time, recent number correct (over a variable number of problems), recent number correct (after adaptation), number correct relative to strength of adaptation, cognitive demand of tasks or problems, a derivative of the speed of answers over time, a derivative of the accuracy of the answers over time. In addition, information for prior interactions or other system-provided information may be used

Partially-Ordered Graph

A unique feature of the present invention is the method used to sequence lessons automatically as a result of the assessments.

FIG. 1 shows a partially-ordered graph which may be constructed by mapping the lessons to graph nodes 102 and the requirements to directed graph edges 104.

At any given time, the student's current profile, containing their current status against all of the micro-objectives, may be combined with the graph in order to determine the exposed surface of the graph, or wavefront, 106 applicable to the student at this time. Lessons that the student is no longer eligible for 120, based on the assessments, are those lessons which are before the wavefront (on the left in the figure). Lessons the student is currently eligible for or will be eligible for in the future 130, again based on the assessments, are after the wavefront (on the right in the figure). Lessons the students is currently eligible for 132 are the future lessons which are on the wave front. These are the lessons (nodes) whose incoming paths (directed edges) cross the wavefront.

Every time an assessment is done (normally at the end of a lesson), a new wavefront can be calculated. FIGS. 2A, 2B, and 2C show such a recalculation. At the start, in FIG. 2-A, the student has done no lessons. When they complete one, the wavefront 106 changes as shown in FIG. 2B and different lessons 132 become available. These lessons becomes available based on the level of mastery achieved, not because a lesson was completed. As the level of mastery for each student may be different, it will be appreciated that the graph for each student may be quite different. It is possible for the wavefront to remain unchanged after a lesson has been completed, even though micro-objective scores may be adjusted. It is also possible for a lesson to no longer be available even if it has not been done by the student. The change in the wavefront from that shown in FIG. 2B to that shown in FIG. 2C could occur from the completion of any of the lessons the student was eligible for as of FIG. 2B.

Additional information may be factored into the graph. In particular, information from the student profile may modify the graph of lessons by altering the way in which the assessments and requirements are applied. Note that some embodiments may be capable of making some lessons unreachable when student profile information is filtered in. FIG. 3 shows such a graph, which is a modification of the graph shown in FIG. 1, and which includes different paths between the lessons and some unreachable/unavailable lessons 302.

It is not necessary to actually build the graph to calculate the wavefront and in some embodiments only the wavefront is directly calculated.

As a further refinement, each requirement and assessment may have associated score ranges, which allows for a better understanding of the student's current knowledge and progress. When the extra information is incorporated into the calculated graph the incoming paths to each lesson more accurately reflects the relationship between lessons and therefore the calculated wavefront more accurately reflects the student's knowledge and which lessons should be available. One embodiment uses this feature of the invention using a score of 0 to 100, plus unrated, for each micro-objective in requirements, assessments, and in the student profile.

Unless the wavefront has progressed to the end of the available lessons, the student will always have at least one, and possibly many, lessons available. Offering too many lessons to a student may be undesirable, so another feature of the present invention is limiting the list of available lessons that are presented to the student. Priority is given to those lessons for which the student's profile ranks them highest. This list is then limited by a total number of lessons to be presented, based on a limiting factor. In one embodiment, the limiting factor may be age, with younger kids receiving fewer choices and older kids receiving more choices. In some cases, the limiting factor may be any factor (e.g. the student's learning style) by which students may be clustered or classified into groups. Where there are still too many lessons to present, based on equivalents priorities, a subset selection method is used. In one embodiment, a round robin method is used as the subset selection method, so that the user sees different lessons on each subsequent presentation. One skilled in the art would appreciate that a number of alternative ranking methods might be used to select the subset of lessons to present to the student.

In one embodiment the system 1004 may also choose a single lesson for the student, in several situations. In one ease a single lesson ranks so much higher than all other lessons that it becomes the single lesson to be presented. In another case, the student may have just completed a lesson and the system has seen a high degree of success in following that lesson with another particular lesson.

When the system chooses a particular single lesson for a student, it may skip the normal user interface presented for choosing lessons and may seamlessly switch from one lesson to the next.

Although automatic sequencing is very powerful, there may be times when a specific sequence is needed, such as to comply u a particular standard. Therefore, another feature of the present invention is to allow for manually-specified sequencing.

In one sense lessons delivered by the system 1004 may be considered to be both instruction and assessment at the same time. In other systems, educational content is divided into instruction and examination, with instruction providing information to the student and exanimation testing the student's knowledge. These systems may present examinations as games or fun activities, but the effect is the same. In contrast, the system 1004 of the present invention uses lessons which interweave instruction and assessment. In accordance with the techniques disclosed above, an assessment algorithm is continuously assessing a student, and instructional information provided to a student is adapted based on the assessment of the student. In one embodiment, the instructional information may be provided in the context of a particular problem given to the student during a lesson. In some cases, the lesson may take the form of a game that the student plays. However, even in such cases, the assessment algorithm constantly assesses the students and adapts instructional information presented to the student while the student plays the game. The assessment algorithm may be configured to assess and reevaluate the student periodically, say after every problem.

Reporting

Reporting allows a student or parent to know where they are in making progress toward their educational goals. The standards hierarchy of the present invention allows for a more flexible report to be generated. FIG. 9 shows such a report 900 for student 910. The report includes contextual information such as a subject 920 which might have overall status information 930. A state standards status value 940 might also be shown with the overall status information. The report can also have projected test scores 980.

Each level within the standards hierarchy may have a function attached to it, which is used to calculate a score for that item. In addition, each node in the standards hierarchy may optionally have an alternate function attached to it, which substitutes for the generic function for that level or it may have alternate functions attached to it which apply to lower levels in the standards hierarchy.

In one embodiment, the default functions for score calculation at all levels other than the lowest level are a class of formulas:
score average=(values)*(kˆ average(logₖ(each value/average(values)))
and
score average=(values)*(logₖ(average(kˆ(each value/average(values))

The actual formulas and the constant value k are tuned over time.

Other embodiments may use other default functions including but not limited to a simple percentage value, or a weighted computation over the lower level scores.

State and Local Standards and Requirements

Although the present invention provides for the specification of a set of standards, as described above, there are many differing standards in use. In the United States alone, there are standards in each of the fifty states. Parents naturally want their student's progress reported to them in a manner that is relevant to the state and/or other local standards they are expected to meet. A feature of the invention provides for this, by allowing each item in the standards hierarchy to be optionally mapped to a plurality of each local standards in each set of state standards provided for in the system. FIG. 8 shows an exemplary mapping. Mappings may be assigned to any level of the hierarchy and such mappings may vary by locality, as shown by topic mapping 810, objective mapping 820 and micro-objective mappings 830a, 830b, 840a, and 840b. Mappings may also vary in how they are applied. Mappings 830a and 803b map two different micro-objectives to the same local standard, while mappings 840a and 840b map the same two micro-objectives to two different local standards. While state and local standards have been discussed above, it is possible to use the techniques of the present invention to map a student's progress to any standard in general and not just to state and local standards,

Given such a mapping, a report or summary can be generated of a student profile or of the delta of a student profile which shows the students knowledge and/or progress in terms of such local standards. Note that it is possible for a local standard to be unmapped to a system standard and vice versa. Such cases can be noted in a report.

The local standards mapping just described does not affect the student profile or the partially-ordered graph or calculated wavefront discussed previously—it affects reporting only. However, some state standards may require certain topics to be taught n a particular order. Therefore, another feature of the invention is to allow(w) for the specification of state standard-specific manually-specified ordering, allowing for lesson ordering to be modified for a particular local standard.

In addition to local standards mapping, it is possible for a local standard to add additional micro-objectives that do not map to any globally available micro objective. Such a local micro-objective might be desired, for example, for state-specific knowledge taught in a course such as history. Lessons which teach the appropriate information also need to be added to the system and matched against Such a micro objective.

In addition, local standards may specify alternate score evaluation functions, as described above, which apply only when a given local standard applies.

In some embodiments, instead of mapping micro-objectives to standards in a set of standards that may be state, local or third-party standards, it is possible to provide reports on the micro-objectives themselves. This can be done by providing a report on the micro-objectives as mapped to the standards, but allowing reports on the micro-objectives to be viewed without the mapping. In some cases, a parameter may, be set to control whether reporting occurs at the micro-objective level or at the standards level.

Mapping to Standardized Tests

The standards mapping and ordering described above can be applied in another novel way, to standardized tests such, as the SAT, PSAT, ACT, ITBS, or Washington State's WASL. Using such standards mapping, a report can be generated which shows how a student is performing against what is expected of them for a standardized test. And test-specific manually-specified ordering can be used to modify lesson ordering to better fit the requirements for such a test.

Note that the mappings for such tests are not the examinations themselves, but rather a mapping to the knowledge that a student must master (as represented by micro-objectives) in order to pass the test.

In one embodiment, a Standardized Test Predictor may be built as part, of the reporting for a standardized test. A Standardized Test Predictor is an algorithm that computes a synthetic score for a standardized test for a student based upon the student's mastery of the required objectives for the test. Such a predictor for the SAT, for example, would allow a report to compute an instantaneous estimate of a student's actual SAT score at any time.

In one embodiment, the quality of the projection of such scores may be improved by confidentially collecting the real test scores after the fact, or, perhaps, acquiring it from a testing authority.

In another embodiment, the system could replace a standardized test and provide an equivalent score. A typical student spends many hours using the systems, in contrast to very few hours spent taking a standardized test. Thus, a test result from the system is both more accurate and more detailed than the result from a standardized test can be.

Processing Assessments and Proposing Lessons

FIG. 11 shows an exemplary process 1100 for adjusting a student's profile in response to a completed lesson. In step 1105, a lesson is completed on the client. In step 1110, a number cf substeps are repeated for all assessment rules in the lesson. In step 1112, a collection is made of all the problems that the current rule being evaluated applies to. In step 1114, the problem collection is examined to see if there are enough problems to evaluate the rule. If not, the subprocess ends in step 1118 and the loop moves to the next applicable assessment rule.

Otherwise, in step 1116, a proposed value for the assessment is calculated using the rule. Next, the subprocess ends in step 1118 and the loop motives to the next applicable assessment rule. After subprocess 1110 has evaluated all rules, step 1130 performs a number of substeps for each micro-objective assessed by the lesson. In step 1132, the highest calculated proposed value is chosen from among all of the proposed values from step 1110, and, in step 1134, this value is submitted to the server. The subprocess ends in step 1136 and the loop moves to the next applicable micro objective. After subprocess 1130 has processed all of the micro-objectives, step 1150 submits a request to the server for the next possible lessons.

FIG. 12 shows an exemplary process 1200 for proposing a set of lessons for a student. In step 1205, the server receives a request for lessons from the client. In step 1210, a number of substeps are repeated for each subject being studied by the student. In step 1220, a number of substeps are repeated for each lesson in the current subject. In step 1222, the student's profile is examined to see if they meet the minimum requirements for the lesson. If they do not, the inner subprocess ends in step 1228 and processing proceeds to the next applicable lesson. Otherwise, in step 1224, the student's profile is examined to see if they exceed the maximum requirements for the lesson. If they do, the inner subprocess ends in step 1228 and processing proceeds to the next applicable lesson. Otherwise, in step 1226, the lesson is added to the collection of lessons available to the student, along with a priority value based on how the student's micro-objective scores compare with the lesson's requirements. Next, the inner subprocess ends in step 1228 and processing proceeds to the next applicable lesson. After all applicable lessons have been processed, the outer subprocess ends in step 1212 and processing proceeds to the next applicable subject. After all applicable subjects have been processed, the list of collected lessons is examined in step 1230 to see if there is one lesson which has a priority value which is significantly higher than any other priority value. If so, in step 1235, that lesson is chosen as the single lesson that the student will do next, and the process ends. Otherwise, in step 1240, the collection of lessons is examined to see if the number of lessons is less than or equal to the maximum number allowed to be proposed to the student. If the maximum is not exceeded, the entire collection is chosen in step 1245 and will be presented to the student, and the process ends. Otherwise, in step 1250, the collection of lessons is sorted by priority, and, in step 1260, the highest priority lessons, up the maximum number allowed to be proposed to the student, are chosen arid the process ends.

For example, using the processes in FIG. 11 and FIG. 12, a student could have a number of lessons available to them to teach the concept of addition. In FIG. 133A, the student is given a choice of lessons A, B, and C. The student completes lesson A and subsequently gets a choice of lessons C, D, and E. Note that lesson B is no longer available, either because it is no longer applicable based on what the student learned in lesson A (because A and B have overlapping micro-objectives), or because it is no longer a high priority. Such overlapping objectives occur in many lessons because an important part of learning, and particularly early learning, is teaching multiple ways of knowing, so multiple lessons are built that teach the same underlying concept in different ways. Next the student completes lesson D and subsequently gets a choice of C, E, and F.

In contrast to FIG. 13A, in FIG. 13B, the student is given the same choice of lessons A, B, and C, but chooses to do lesson B first. This student subsequently gets a choice of A, D, E, and G. Note that both the set of available lessons is different, as is the number of available lessons.

Next the student completes lesson D, the same second lesson as in 13A, but here the student is given a choice of A, E, and G.

FIG. 14 of the drawings shows an example of hardware 1400 that may be used to any of the client systems 1404 and the server system 1406, in accordance with one embodiment of the invention. The hardware 1400 typically includes at least one processor 1402 coupled to a memory 1404. The processor 1402 may represent one or more processors (e.g., microprocessors), and the memory 1404 may represent random access memory (RAM) devices comprising a main storage of the hardware 1400 as well as any supplemental levels of memory e.g., cache memories, non-volatile or back-up memories (e.g. programmable or flash memories), read-only memories, etc. In addition, the memory 1404 may be considered to include memory storage physically located elsewhere in the hardware 1400, e.g. any cache memory in the processor 1402 as well as any storage capacity used as a virtual memory, e.g., as stored on a mass storage device 1410.

The hardware 1400 also typically receives a number of inputs and outputs for communicating information externally. For interface with a user or operator, the hardware 1400 may include one or more user input devices 1406 (e.g., a keyboard, a mouse, heart rate monitor, camera, etc.) and a output devices 1408 (e.g., a Liquid Crystal Display (LCD) panel, a sound playback device (speaker), a haptic device, e.g. in the form of a braille output device).

For additional storage, the hardware 1400 may also include one or more mass storage devices 1410, e.g., a floppy or other removable disk drive, a hard disk drive, a Direct Access Storage Device (DASD), an optical drive (e.g. a Compact Disk (CD) drive, a Digital Versatile Disk (DVD) drive, etc.) and/or a tape drive, among others. Furthermore, the hardware 70 may include an interface with one or more networks 1412 (e.g., a local area network (LAN), a wide area network (WAN), a wireless network and/or the Internet among others) to permit the communication of information with other computers coupled to the networks. It should be appreciated that the hardware 1400 typically includes suitable analog and/or digital interfaces between the processor 1402 and each of the components 1404, 1406, 1408, and 1412 as is well known in the art.

The hardware 1400 operates under the control of an operating system 1414, and executes various computer software applications, components, programs, objects, modules, etc. to implement the techniques described above. Moreover, various applications, components, programs, objects, etc., collectively indicated by reference 1416 in FIG. 14, may also execute on one or more processors in another computer coupled to the hardware 1400 via a network 1412, e.g. in a distributed computing environment, whereby the processing required to implement the functions of a computer program may be allocated to multiple computers over a network.

In general, the routines executed to implement the embodiments of the invention may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processors in a computer, cause the computer to perform operations necessary to execute elements involving the various aspects of the invention. Moreover, while the invention has been described in the context of fully functioning computers and computer systems those skilled in the art will appreciate that the various embodiments of the invention are capable of being distributed as a program product in a variety of forms, and that the invention applies equally regardless of the particular type of computer-readable media used to actually effect the distribution. Examples of computer-readable media include but are not limited to recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

While certain exemplary embodiments have been described and shown in the accompanying drawings, it is to be understood that such embodiments are merely illustrative and not restrictive of the broad invention and that this invention is not limited to the specific constructions and arrangements shown and described, since various other modifications may occur to those ordinarily skilled in the art upon studying this disclosure. In an area of technology such as this, where growth is fast and further advancements are easily foreseen, the disclosed embodiments may be readily modifiable in arrangement and detail as facilitated by enabling technological advancements without departing from the principals of the present disclosure.

1. A method comprising;
defining a plurality of learning objectives;
defining a plurality of micro-objectives, each relating to a particular learning objective; and
providing a lessen to a client system, the lesson comprising a sequence of problems each having associated therewith one of said micro-objectives, the micro-objectives for at least some of the problems being different.

2. The method of claim 1, wherein the sequence of problems comprises choices for problems selectable by a student.

3. The method of claim 2, wherein the problems that are selected are generated automatically based on the different micro-objectives.

4. The method of claim 1, wherein problems, associated with a given micro-objective, are interspersed in the sequence with problems associated with other micro-objectives.

5. The method of claim 1, wherein at least some of the problems have more than one micro-objective associated therewith.

6. The method of claim 1, further comprising generating an assessment for the lesson, the assessment comprising a score for each micro-objective biased upon the problems associated with the micro-objective.

7. The method of claim 6, wherein the score is based on an evaluation of factors relating to how the problems were answered, the factors being selected from the group consisting of a time spent answering each problem, an overall time spent on the lesson, and a measure of a correctness of responses associated with the problems.

8. The method of claim 6, further comprising mapping the score for each micro-objective to standards set by a standards authority to provide an assessment of said standards.

9. The method of claim 8, further comprising providing a report on a student's performance in terms of the standards.

10. A method comprising:
defining a plurality of learning objectives;
defining a plurality of micro-objectives, each relating to a particular learning objective;
defining a plurality of lessons;
assigning a requirement to each lesson to control an availability of the lesson to a student;
forming an assessment of the student comprising a score for each micro-objective; and
based on the assessment, determining which lessons are available to the student; and
providing a sequence of lessons for the student based on the available lessons to a client system

11. The method of claim 10, wherein the sequence comprises choices for lessons that are selectable by the student.

12. The method of claim 9, further comprising ranking the available lessons based on relevance to the student.

13. The method of claim 12, wherein relevance to the student is based on the assessment.

14. The method of claim 10, wherein providing the sequence of lessons comprises selecting the lessons ranked as relevant.

15. The method of claim 10, wherein the requirement comprises a maximum and a minimum which define a range for a student's micro-objective score

16. The method of claim 10, wherein the sequence of lessons defines a partially ordered set.

17. A system, comprising:
a lesson database comprising a plurality of lessons, each lesson having associated therewith at least one learning objective, the each learning objective having associated therewith at least one micro-objective;
a student assessment engine to calculate an assessment for a student comprising a score for each micro-objective
a lesson sequencing engine to provide a sequence of lessons for the student to a client system based on the assessment, said sequence of lessons defining a partially ordered set; and
a lesson delivery engine to deliver the sequence of lessons to the client system.

18. The system of claim 17, wherein the sequence comprises choices for the lessons that are selectable by the student.

19. The system of claim 17, wherein the sequence of lessons comprises lessons determined to be relevant to the student based on the assessment.

20. The system of claim 17, wherein the sequence of lessons is periodically updated based on updates to the assessment the lesson delivery engine then delivering the updated sequence.

21. The method of claim 17, further comprising a reporting engine to provide a report wherein the assessment is mapped to standards defined by a standards Authority.

22. A computer readable medium having stored thereon a sequence of instructions which when executed by a processor cause the processor to execute a lesson, comprising:
providing a sequence of problems each having associated therewith at least one micro-objective to a client system, the micro-objectives for at least some of the problems being different, and each micro-objective relating to a particular learning objective; and
generating an assessment corresponding to the lesson, the assessment comprising a score for each micro-objective based upon the problems associated with the micro-objective.

23. The computer readable medium of claim 22, wherein the sequence, comprises choices for the problems that are selectable by a student.

24. A method comprising:
storing a knowledge taxonomy in a database, the taxonomy comprising multiple levels of objectives with a lowest level;
presenting instruction to a student in the form of at least one lesson;
forming an assessment of a learner's grasp of the instruction by assessing the lowest-level objectives associated with the lesson;
providing a report for the student, the report comprising the assessment of the lowest-level objectives.

25. The method of claim 24, further comprising providing an assessment of the learner in terms of a standard by mapping the assessment of the lowest-level objectives to the standard.

26 The method of claim 25, further comprising predicting a test score based on the assessment.

27. The method of claim 26, wherein the test is a standardized test.

28. The method of claim 25, wherein the score is presented as a value selected from the group consisting of a raw score, an adjusted score, a percentile, state percentile, and a country percentile.

29. A method, comprising:
providing at least one lesson for a student, the lesson having at least one problem and instructional information associated with the problem;
forming an assessment of the student; and
controlling whether to present the instructional information associated with a problem, based on the assessment.

30. The method of claim 29, wherein the lesson is executed on a client system and takes the form of a game to be played by the student.

31. The method of claim number 29, wherein the assessment is performed periodically during execution of the lesson.

32. The method of claim 29, wherein the assessment is based on micro-objectives associated with the lesson.
